(19) United States
(12) Patent Application Publication
(10) Pub. No.: US 2002/0120520 A1
(43) Pub. Date: Aug. 29, 2002

(54) Shop express

(76) Inventor: Vonnie Chism Hill, Memphis, TN (US)

Correspondence Address: Laverne E. Murray, 3392 Kirby Meadows Drive, Memphis, TN, 38115, US

(21) Appl. No.: 09/790,778

(22) Filed: Feb. 23, 2001

(51) Int. Cl. G06F 17/60

(52) U.S. Cl. 705/26

(57) ABSTRACT

There are a few new art disclosures pertaining to my invention of the ‘SHOP EXPRESS’, that are different from the banking system set up. The ‘SHOP EXPRESS’ set up has a second set of inner cashier that are called operator tellers and scanner tellers, that possess an computer, printer, inhouse and outside telephone, and inhouse computer telephone line, scanner,conveyor belt for groceries, alphabetical grocery holding bins. The front window money terminal teller cashiers will possess T.V. security monitors that contain servaillance camera's within them, Debit/Credit card slashers, voice speakers, also inside the store will have these same type of servaillance camera T.V. monitors for safety security viewing. When entering the money terminal lanes the customer will talk, see, and communicate only with the front window money terminal tellers, whom handle all the customer money distribrutions. The actual money terminal transaction machines are made by Diebold production company. There will be corresponding money terminal parking lanes that range from eight to twelve lanes (or however many the store owner wants), there is a sacker walk-way, or a parking warehousing area; for grocery stock-up and or pick-up. The ‘SHOP EXPRESS’ is surely an added convience to the world of grocery shopping, giving customers that peace of mind, safety, healthy, and fast shopping; hands free convience, with adding a time saving and economical convience to all present and future grocery stores.

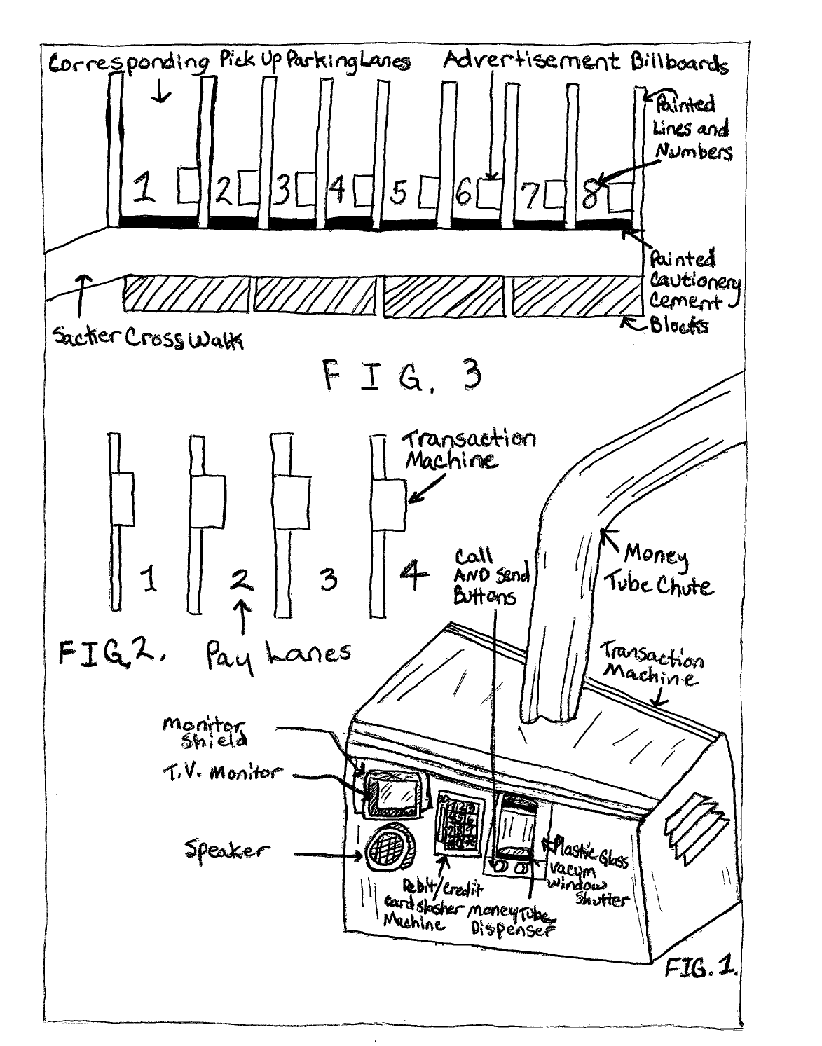

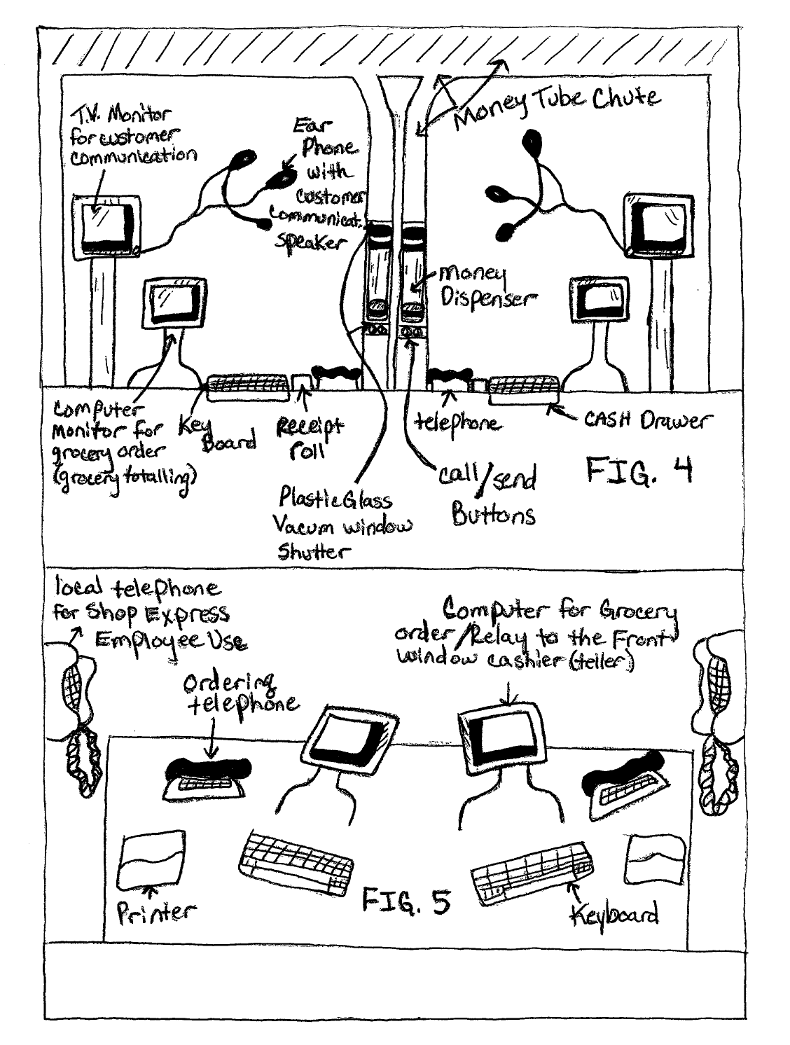

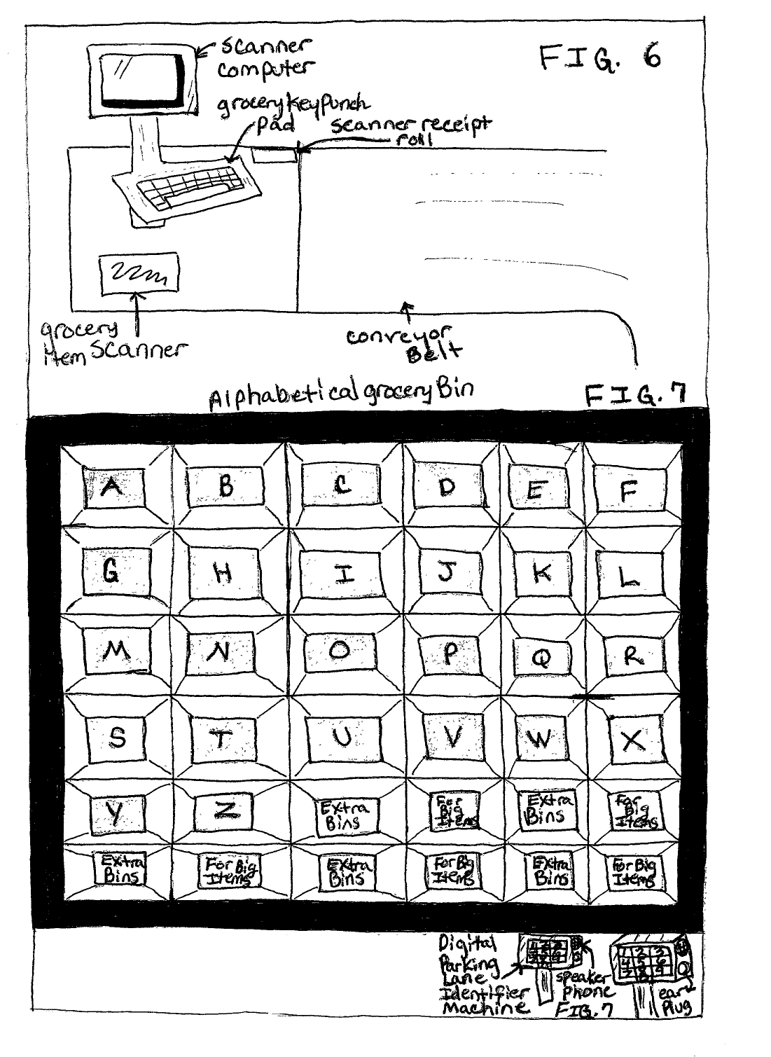

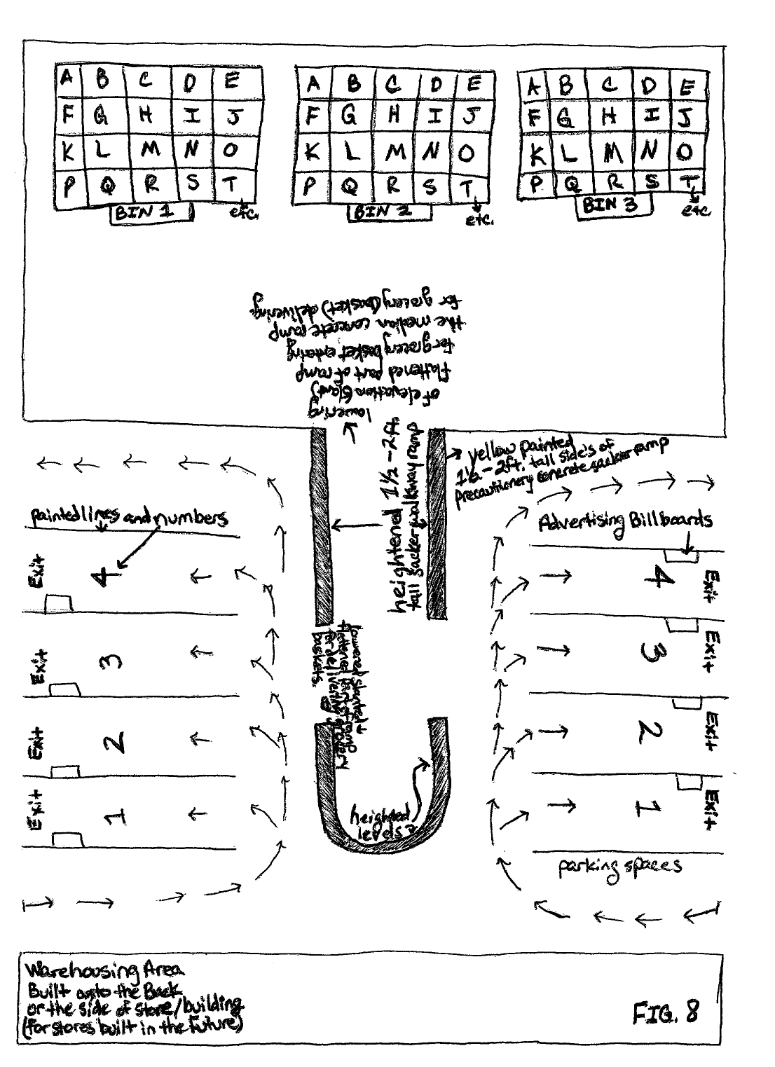

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO A MICROFICHE APPENDIX

NOT APPLICABLE

### BRIEF SUMMARY OF THE INVENTION

The ‘SHOP EXPRESS’ service is designed to allow for a more convient and rapid shopping experience. This service product allows customers to shop for groceries and other small items from the comfort of their home, office, or car phone, etc. The ‘SHOP EXPRESS’ would be configured much like a drive-up teller window at the bank or Walgreens. A shopper, after calling in their order of groceries forty five minutes ahead of time, and of no more than twenty to twenty-five goods, groceries or items, would pull up to a money lane terminal on the outside of the store located on the side of the store. Once in the money lane terminal, at the transaction money terminal machine, the customer tells the cashier their name and telephone number, and show two forms of identification. When the cashier has the required information (and coupons, if any), then they are able to tell the customer how much they owe. The customer the pays the teller and proceeds to the terminal parking lanes that are in front of the money terminal lanes where their items are delivered to their vehicle by the sackers. All returns and unredeemed coupons must be made inside the store at customer service. An additional charge of five dollars will be required to use this service.

### BACKGROUND OF THE INVENTION

The ‘SHOP EXPRESS’ provides for a convenient and efficient method of shopping for small amounts of groceries and other items at a local grocery store or convience mart. Customers will be able to order from home, office, fax, or cellular phone, and then drive to the store a short time later and pick up their items in approximately a fifth-teen minute period of time for the entire service. This service could prove particularly useful to those individuals running on a tight schedule, or handicaps, and others, like pregnant women, elderly people, Asthmatics (people with Emphysema), and people whom just do not like standing in long lines, or crowded places. Some other benefits of ‘SHOP EXPRESS’ are comfort, convience of your car without getting out, or calling in your home gives you a tremendous peace of mind and is energy efficient, and all this in a shor timely fashion. The comfort is having all this service done for you, without virtually having to doa thing, and staying in the convience of your car. Time saving is wonderful because the entire service is done in approximately fifth-teen minutes, with seven to eight minutes in the money terminal lane and about seven minutes in the terminal parking lane. The customer will feel secure because there will be sevailence cameras' attached to the building viewing the money the money terminal lanes and the parking lanes; that tapes and recordes everything, also the ‘SHOP EXPRESS’ entire area will be well lighted and there are small T.V. monitors with servailence cameras inside the money transaction machine for the money cashier teller to view the customer as they speak, plus a T.V. monitor inside the store that views the parking lanes. All customers' will definitely have a peace of mind. This service product (process) is also a advantage to the store owner, because there can be no more than twenty to twenty-five items purchased, therefore larger buying customers will still be forced to come inside the store to look and find other bargains, this convience will bring in loads of new customers to the store, which means more business, and more profit from the increase in business, and more profit from the ‘SHOP EXPRESS’ five dollar service charge. If, the store only allow customers to purchase only twenty to twenty-five items, then there will not be traffic build-up during this process. ‘SHOP EXPRESS’ wants to add comfort and convience; not take away. All customers whom arrive before their forty-five time factor, are not guaranteed such an spontaneous short time factor of exspeediant service, because the sackers' and cashiers' need time to gather and process the order.

### DETAILED DESCRIPTION

The ‘SHOP EXPRESS’ is somewhat set up like the banks' money terminal. There is a large window attached to the side of the grocery store. On the front line are three to four money terminal tellers, and besidfe each teller they have a computer, keypad, cash register, an in house phone, encounter T.V. monitor (or standing monitor) with a hearing aid microphone. These front window money terminal teller cashiers' only deal with accepting cash money, personal and (some creditor) checks, vouchers, coupons, debit and credit cards. Behind the front window money terminal teller cashiers are two operater teller that take the customers' phone order then relay those grocery orders as a printed grocery list with one going to scanner teller and the other going to the sacker puller. The printed grocery list includes the customer's full name, phone number, date and time. The sacker puller returns with the groceryorder items and give it to the scanner teller to scan in order to receive a total for the groceries which includes the added surcharge fee. The scanner teller sends this information via him/her computer to the front window money terminal teller computer. Only the front window money terminal teller can discount the customer's coupons upon the customer's arrival, due to customers' often forget their coupons at home. Once the customer's grocery order has been bagged, the sacker takes the receipt (which includes the customer's full name, telephone number, and the date and time) from the scanner cashier and staple it to that particular customer's grocery bag, it is placed in the designated grocery store's alphabetical labelled holding bin. Remember behind the front window money terminal teller cashiers are two operator tellers and two scanner tellers whom are positioned in front of the operateor tellers, in which both sets of these tellers are blocked off from the front window money terminal tellers by a reflector type glass (mirrored) window, or wall. At the operator teller and scanner teller stations, it contains a keypad, printer, receipt roll, phone(that accepts inhouse and outside calls, so that there can be communication between the operator teller and the front window money terminal teller for the purpose of exchanging of the customer grocery ticket information. At the scanner teller station the sacker puller brings the gathered ordered customer groceries here to be scanned and sent down the conveyor belt to the end of the counter in which the scanner's sacker sacks the groceries. Once the grocery order has been bagged and put into the alphabetical holding bins that holds up to fifth-teen to twenty large grocery bags per bin, the groceries stays there until the customer has arrived to the terminal parking lane. The delivery sacker will write the arrived parking lane customer parking lane number on their grocery bag once the customer pushes the grocery store's advertisement standing billboard (or installment stand) buzzer. The buzzer signifies to the delivery sacker inside the store that an customer in buzzing in from a certain parking lane, in which once the customer buzzes in the delivery sacker's digital keypad lights up in the store on that certain parking lane showing that there is a new arival customer occupying that parking lane. At that time the delivery sacker will answer the customer's buzz from the inside relay speaker phone ( that now showing customer's parking lane number, which is digitally enlighted). The delivery sacker will ask that parking lane customer name and also sometimes their phone number, then pull that customer order of the alphabetized bin and write that customers parking lane on their grocery bag and deliver their groceries to them. The sacker will deliver groceries to the car upon the sacker's walk ramp. Customers will be protected from rain or snow by a permanent overledge roofing establishment that containsbright lights tht stands over the parking lanes. And, for all stores built in the future, cars will drive around to a warehousing area, once they have left the money terminal lanes; and picked up their groceries, where it eill be well lighted and weather protected, because of the semi enclosement, keeping everything room tempered, dry and well servaillanced. There will ba a total of eight to twelve parking lanes that will have black and yellow stripped lines signifying warning ‘drive slow’ and ‘do not enter’ but only one way.

### DESCRIPTION OF PREFERRED EMBODIMENT

What Makes Shop Express So Much Better than Previous Inventions

There are several ways ‘SHOP EXPRESS’ is much better than previous inventions and here are a few to name: Safety, Peace of Mind, and Self Assurdnance. In the past there have been some inventions that would let you (as a customer) drive through an designated shopping area within the store and put their chosen groceries into their cars which could cause dishonesty and disprofitability to the store because of theft by a customer, whom could could put groceries into their car, or, and only pay for half of the groceries at the cashier, this could also be unsafe, because playful children can jump in the way of the moving vehicle, by playing even though they are not suppose to be out of the vehicle ( in that drivable setion of the store, it is also unhealthy because of vechicle combustion of poisioness fumes, and vehicle break downs in the drive through line, therefore this invention of better serving the people is unsafe and unhealthy. Another invention in the past, is there has been stores that do their own grocery delivery to peoples' houses, but the rate of crime has increased do tremendously these days, that the customer could be subject to herendous dangerous crimes such as robbery, rape, assault, or aggravated assaualt within their own home, after the customer have invited the criminal in to deliver their groceries, letting the criminal were he/she would not be charged with breaking and entering. One other invention of the past is the T. V. grocery ordering or the Federal Express grocery ordering delivery, but this way the customer can mainly only receive freezed dried groceries, not that juicy red steak, ground chuck, or cold milk, etc., etc. Most people want that straight out the store food freshness, coldness, and tastfulness of a product, plus the customer can inspect their food items before they leave the store. I would like to reiterate on the drive through store invention that, that invention only provides a certain number and type of designated foods and items to choose from. People should not have to be limited to buying only certain foods, goods or items, besides only those pre choosen foods, goods, or items that were pre-selected by the store might not be some of the items the store has on sale.

### IDENTIFICATION DESCRIPTION OF DRAWINGS

FIG. I.

1. MONEY TRANSACTION MACHINE

a. This machine serves as a center for the exchange of monies, coupons, debit/credit cards, identification, voice and physical imagery views between the customer and the money terminal teller.

2. MONEY TUBE CHUTE (FIG. I.)

a. Monies and other collections are sent back and forth between the money terminal teller and the customer within the money tube dispenser, through the suction vacummerized money tube chute.

3. CALL AND SEND BUTTONS (FIG. I.)

a. Call button is pushed by the customer or the money terminal teller for voice communication between the two whom are speaking.

b. Send button is pushed by the customer or the money teller when forwarding a transaction (concerning monies, coupons, debit/credit cards and identification) from one to the other.

4. MONITOR (FIG. I.)

a. This is used for the customer and the money teller to view each other as they Speak.

b. Plus the customer's monitor has a hidden recording camera within it to record any criminal activity that may be going on within the vehicle that may pose a threat to the store (or it's system's technicle environment).

c. The store's central monitoring recording camera, and an extra T.V. monitor for sevaillance viewing of the money terminal lanes and parking lanes will be located in the store's central office.

5. MONITOR SHIELD (FIG. I.)

a. This is an aluminum or steel plated hard flattened cover appearing looking Screen shield that extends (or slides out from) the encasement of the money Transaction machine covering over the T.V. monitor (like a topping) to protect The T.V. monitor's glass screen from overnight vandellism.

b. The monitor shield is let down and used as protection for the monitor at the end of the last worked shift or whenever ‘SHOP EXPRESS’ system is not in use.

c. The monitor shield will be controlled from the inside, in the money teller's Booth (by a remote button) by the money terminal teller.

6. SPEAKER (FIG. I.)

a. The speaker is used for voice communication between the money terminal teller and the customer.

b. The speaker does not necessarily be made in the form of a circle, it also could Take other frames; such as a square or rectangle, etc.

7. DEBIT/CREDIT SLASHER MACHINE (FIG. I.)

a. Any customer whom wishes to use their Debit or Credit card in ther form of Payment for their grocery order may do so by either slashing their card through or entering their code, then once ther card has been accepted, this machine will print out two receipts or carbon copied receipt the customer is to sign one of the receipts and send it back to the money terminal teller and keep the other receipt.

b. Only the money terminal tellers computer screen will show whether the card Has been accepted or declined.

8. MONEY TUBE DISPENSER (FIG. I)

a. This is the monies, coupons, identification and receipt collection tube that is sent and exchanged back and forth between the customer and money teller for the completion of a grocery payment transation.

FIG. II.

1. PAY LANE

a. These are the paying (transaction) lanes that the customer must enter with the vehicle in order to pay for their grocery orders.

b. In the Pay Lanes are where the money terminal transaction machine are located for the purpose of initiating and completing the grocery order transaction.

c. Customer/Vehicle must proceed through the pay lane before entering the Pick Up Parking Lane.

FIG. III.

1. PICK UP PARKING LANE

a. Once a customer has completed their grocery transaction (paid for groceries) they are to proceed from the ‘Pay Lane’ to the ‘Pick Up Parking Lanes, push the buzzer on the near by Advertisement Billboard (which identifies it's parking lane), and wait for the sacker to bring out their groceries.

2. ADVERTISEMENT BILLBOARD (FIG. III.)

1.

a. The advertisement billboard enlighted or highlighted commercial ad of store's grocery ad for that particular week or (whatever the store wants to commercialize). This commercial ad is encased in a clear plastic/glass type window were it can be greatly visually seen by the customer whom is interested in that particular week's sales items while they wait for their groceries to be delivered to their car.

b. The Advertisement Billboard has a buzzer button that the customer's push, Which will eluminate on the ‘Digital Parking Lane Machine Keypad’ inside the store, on the ‘Digital Parking Lane Identifier’, were the delivery sacker identifies, The parking lane number that's digitally enlighted. The billboard also contains a speaker for voice communication between the customer and the sacker.

3. PAINTED LINES AND NUMBERS (FIG. III.)

a. The ‘Parking Lane Lines’ are painted in white on each side of the parking lane, to show lane separation.

b. The Parking Numbers are painted in a deep yellow so, the different parking Lanes can be easily identified.

4. PAINTED CAUTIONARY CEMENT BLOCKS (FIG. III.)

a. The ‘Cautionary Cement Blocks’ that are directly in front of parking lane are the length from the painted white line of one parking space to the other painted white line of the same parking space.

b. The color of the cautionary cement block that's located directly in front of the parking lane, is the same deep yellow as the number. The yellow color is suppose to display a mental thought of caution (Do Not Cross Pass This Point of Orgin).

c. The Painted Cement Block/Blocks in front of the ‘Sacker Cross Walk’ is painted the same deep yellow and it has jet black horizontal lines painted over the yellow, as a mental thought of caution to the on coming money terminal transaction lane drivers commanding them to be aware, go around, do not pass this point of origin. These painted cement blocks is to protect the sackers walkway and the on coming pick up parking lanes. Also, these particular painted cement block/blocks may come in four large blocks; the length of two parking or just one extra long block that covers that entire sacker crosswalk length.

5. SACKER CROSS-WALK (FIG. III.)

a. The purpose if the ‘Sacker Cross-Walk’ is for the sacker's use of walking with The customers grocery order in a grocery cart to deliver groceries to the customer without having to walk the carts between and behind customer vehicls, and the grocery carts won't damage the customers vehicle this way, plus the cross-walk provides a great degree of protection for the ‘sackers’ from the parking lane vehicles and the on coming money terminal transaction lane vehicles.

FIG. IV.

1. Ceiling (FIG. IV.)

a. The ‘Ceiling enhouses the ‘Money Tube Chute’, which enhouses the Money Dispensers which carry the monies, coupons, identification, etc., etc.

2. EARPHONE (FIG. IV.)

a. The ‘Earphone’ are attached into the T.V. monitor and used for speech Communication between the money teller and the customer or the money terminal teller can speak to the customer over the speaker phone.

3. T.V. MONITOR

a. This monitor is used for visual communication between the money terminal teller And the customer.

b. The monitor also serves as a security element, because it has a hidden camera behind it's screen that can record any type of criminal intentions toward the store or it's work crew.

4. COMPUTER MONITOR (FIG. IV.)

a. The ‘Computer Monitor’ is used for bringing up the customers grocery order and total's, communicating with the operator tellers, and the information and application concerning any ‘Shop Express’ money terminal transactions.

5. KEYBOARD (FIG. IV.)

a. This is used for entering any information concerning the ‘Shop Express’ process.

6. RECEIPT ROLL (FIG. IV.)

a. The ‘Receipt Roll’ takes tally of the customers grocery items and it's charges and totals, once the customer has paid their money and their form of payment.

7. TELEPHONE (FIG. IV.)

a. The telephone is another method for the money terminal tellers and the operator tellers and the store's management to communicate.

8. MONEY TUBE CHUTE (FIG. IV.)

a. These ‘Money Tube Chutes’ are located on the inside the store where the money terminal tellers are for their use in transferring back the monies, and identification, etc., back to the customer by the way of the call/send buttons.

FIG. V.

1. LOCAL TELEPHONE (FIG. V.)

a. This telephone is used for voice communication for management and all the ‘Shop Express’ employees for inside and local phone calls only.

2. ORDERING TELEPHONE (FIG. V.)

a. This telephone is used for voice communication between the ordering customer (whom is placing an order), and the operator teller.

3. COMPUTER (RELAY SYSTEM) (Fig.)

a. This computer is used by the operator tellers.

b. The customer's full name, telephone number, and grocery order is typed into this computer, then that information is relayed to the scanner teller and to the sacker puller.

c. Once the sacker has pulled that customer's order and taken it to the scanner teller, the scanner teller scans the groceries and comes up with a tital and gives that customer's information ticket (contains the customer's name, phone number, grocery items and charges and total) to the sacker puller whom gives it to the operator teller. The operator teller the types the customer's grocery total in with the information he/she already has on the customer and sends this information via computer to the money terminal tellers computer for the customers money transaction process.

4. KEYBOARD (FIG. V.)

a. Once again the ‘Keyboard’ is used to type in information concerning the ‘Shop Express’ grocery ordering system process.

FIG. VI.

1. SCANNER COMPUTER

a. This is the same computer screen that's used in most all other grocery stores that visually shows the operator teller and the customer the grocery items and its charges as the items that are being scanned, and finally the grocery items total.

2. GROCERY KEYPUNCH PAD (FIG. VI.)

a. This particular keypunch pad is used for entering the purchase amount of an grocery store item that the scanner might not pick up.

3. SCANNER RECEIPT ROLL (FIG. VI.)

a. This is the receipt ticket with the name of the grocery items and it's individual charges and totals, which is attached to the customers information ticket (that contains their name, phone number, and listing of their grocery items), that the sacker puller used to attain the grocery items. Once the scanned grocery items have been totalled a (ticket) receipt will be produced and attached to the customer informational ticket, and the sacker puller should give this to the operator teller to process in her's/his computer, to afterwards process through to the money teller's computer.

4. CONVEYOR BELT (FIG. VI.)

a. The ‘Conveyor Belt’ is the encounter that (in most grocery stores), in a slow moving motion moves the grocery items from the top portion of the counter (near the scanner) to the far end of the counter (near the sacker, whom will be sacking (packing) the grocery items).

FIG. VII.

1. ALPHABETICAL BINS

a. These alphabetized holding bins, are used to store (enhouse) a customer's ordered filled grocery items in these bins in alphabetical order by the customer's last name until the customer arrive for their grocery pick up.

b. The ‘Bins’ should be large enough to hold 15 to 25 large brown paper bags in each individual bins.

c. If a customer prefer plastic then the sacker may put the grocery items in plastic sacks, then put the plastic sacks in one large brown grocery bag, to be stored in a bin.

2. DIGITAL PARKING LANE IDENTIFIER MACHINE (FIG. VII.)

a. The numbers on this enlighted digital keypad lights up when the customer, pushes the buzzer rom the advertisement ad billboard of their parking lane, letting the delivery sacker know that a new arrived customer is now occupying that parking lane awaiting their grocery pick up delivery. There should be at least two per store ‘Digital Parking Lane Identifier's.

3. EARPHONE PLUG (FIG. VII.)

a. The delivery sacker uses the earphone plug as a optic if he/she wants to use the earphone to communicate with the customer whom is speaking through the advertisement ad billboard speaker, telling the sacker his/her full name (and in some cases the phone number is included, due to having the same name as another customer). The sacker tells the customer “Thank You for Shopping with ‘Shop Express’ at (the store's name) and your delivery will be out soon”. The delivery sacker then write down that customer's parking lane number that he/she see's on the enlighted digital keypad, then go over to the alphabetical bins, then pull that customer's order and write the parking lane number on the brown grocery paper bag with a magic marker, then push the enlighted parking digital number twice on the digital keypad to clear the enlighted number, (or this process can be done before the ever goes over to the bins to write the parking number on the bag).

4. SPEAKER PHONE (FIG. VII.)

a. This is used when the earphone's are not used when the delivery sacker is communicating with the parking lane customer (earphone and/or hands free. But, when there is a lot of surrounding noise going on inside the store, it may be hard for the sacker or customer to ear clearly, so, in such cases the earphones will be best used.

1. What I claim as my invention is: a true economical, money saving, time saving, safe, healthy, and stress free, and virtually hands free convience.”

2. I also claim that my invention would definitely be a profit builder to the grocery stores'that occupy this service, through direct profit; from the five dollar extra fee per customer for this added convience, plus the store can profit indirectly by attracting even more customers to that store's location; because of the extra valued convience.
